(19) United States
(12) Patent Application Publication
(10) Pub. No.: US 2010/0309348 A1
(43) Pub. Date: Dec. 9, 2010

(54) IMAGE PICKUP DEVICE, IMAGE PICKUP SYSTEM, AND METHOD OF DRIVING IMAGE PICKUP DEVICE

(75) Inventors: Kazuyuki Shigeta, Yokohama-shi (JP); Seiji Hashimoto, Yokohama-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/792,543

(22) Filed: Jun. 2, 2010

(30) Foreign Application Priority Data
Jun. 5, 2009 (JP) 2009-136370

(51) Int. Cl. H04N 5/335

(52) U.S. Cl. 348/273; 348/302; 348/E05.091

(57) ABSTRACT

Integers n and k are set to be equal to or greater than 1, and reading of signals from pixels is controlled as follows. In a first frame, signals are output from pixels in every (n+1)th row of the pixel array, and in a second frame following the first frame, signals are output from pixels that are different from the pixels from which the signals are output in the first frame and that are located in a first set of rows defined by selecting every (k+1)th row of the pixel array.

### BACKGROUND OF THE INVENTION

1. Field of the Invention

The present invention relates to an image pickup device, an image pickup system, and a method of driving an image pickup device.

2. Description of the Related Art

In an image pickup apparatus, it is known to control an operation such that signals associated with different areas are output. Japanese Patent Laid-Open No. 2005-86245 discloses a technique in which signals are read from pixels in two modes, i.e., a central-area continuously-reading mode and a whole-area intermittently-reading mode that are switched alternately every frame such that in the central-area continuously-reading mode, signals are read continuously from a plurality of adjacent pixels in a central area of a pixel array, while in the whole-area intermittently-reading mode, signals are selectively read from the whole area of the pixel array while thinning the pixels.

In Japanese Patent Laid-Open No. 2005-86245, it is disclosed with reference to FIGS. 5 and 6 that signals read from some pixels are used in common in both the whole-area intermittently-reading mode and the central-area continuously-reading mode. However, in this technique, an accumulation period cannot be set to be longer than one frame time determined by a frame rate, and thus, if the frame rate is increased, sensitivity decreases with increasing frame rate.

After signals are read for the whole area while thinning pixels, if reading from the same pixels is performed without resetting the pixels in the central-area continuously-reading mode, then the accumulation period becomes different between the pixels used in the whole-area intermittently-reading mode and pixels that are not used in the whole-area intermittently-reading mode. The difference in accumulation period causes not only a difference in signal intensity but also generation of an image lag for a moving subject.

In Japanese Patent Laid-Open No. 2005-86245, it is also disclosed with reference to FIGS. 12 and 13 that rows are selected in a nonperiodic manner in the central-area continuously-reading mode. However, if an image is produced using the signals read from pixels in the rows selected in the nonperiodic manner, aliasing occurs, which causes degradation in image quality.

### SUMMARY OF THE INVENTION

In an aspect of the present invention, there is provided a device including a pixel array including pixels each configured to output a signal obtained via a photoelectric conversion, and a control unit that selects pixels of the pixel array in units of rows and outputs signals from the selected pixels, the control unit configured to control outputting of signals such that for integers n and k equal to or greater than 1, in a first frame, first signals are output from first pixels in every (n+1)th row of the pixel array, and in a second frame following the first frame, second signals are output from second pixels and are located in a first set of rows defined by selecting every (k+1)th row of the pixel array.

Further features of the present invention will become apparent from the following description of exemplary embodiments with reference to the attached drawings.

### BRIEF DESCRIPTION OF THE DRAWINGS

FIG. 1 is a diagram illustrating an example of a configuration of an image pickup device according to an embodiment of the present invention.

FIG. 2 is a diagram illustrating an example of a configuration of a pixel according to an embodiment of the present invention.

FIGS. 3A to 3D are diagrams schematically illustrating image sensing areas according to an embodiment of the present invention.

FIG. 4 is a diagram illustrating an example of a configuration of a control unit according to an embodiment of the present invention.

FIG. 5 is a diagram illustrating an example of a configuration of an image pickup system according to an embodiment of the present invention.

FIGS. 6A and 6B are diagrams illustrating image sensing areas according to an embodiment of the present invention.

FIGS. 7A and 7B are diagrams illustrating image sensing areas according to an embodiment of the present invention.

### DESCRIPTION OF THE EMBODIMENTS

### First Embodiment

A first embodiment of the present invention is described below with reference to the accompanying drawings.

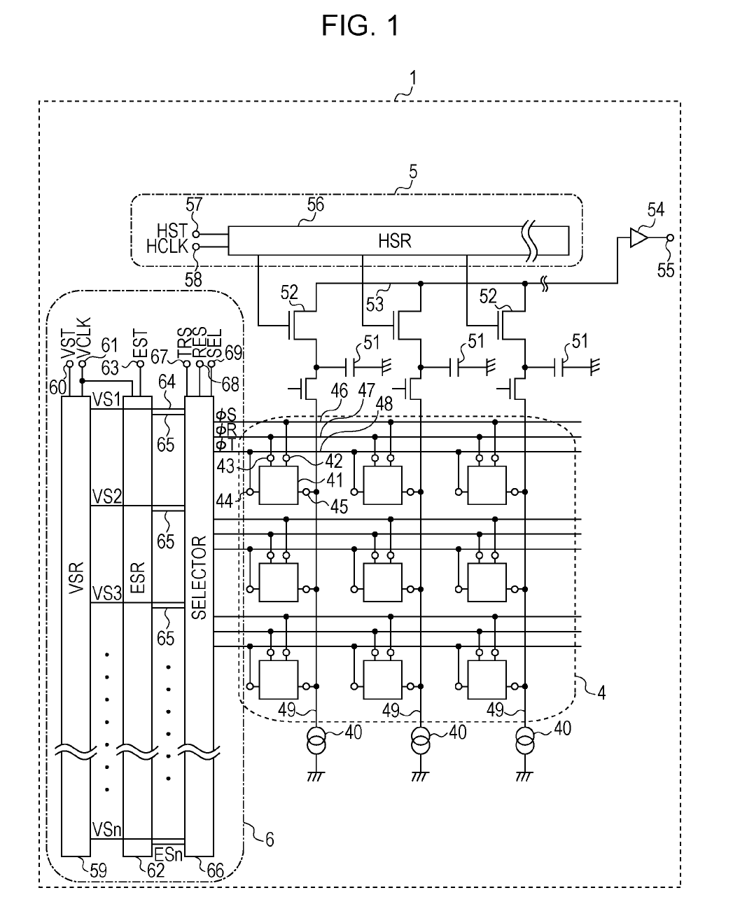

FIG. 1 illustrates a configuration of an image pickup device according to an embodiment of the present invention. The image pickup device 1 includes a pixel array 4 including pixels 41 arranged in the form of a matrix. In the example shown in FIG. 1, for simplicity of illustration, only 3×3 pixels are shown. In the pixel array 4, operations of pixels such as resetting, charge accumulation, and signal reading are controlled in units of rows in accordance with a signal supplied from a vertical scanning unit 6 serving as a row selection unit. Signals output from the vertical scanning unit 6 are transmitted to pixels via signal lines that are provided such that all pixels in each row are connected in common to one signal line. The vertical scanning unit 6 includes a vertical shift register VSR, a electronic-shutter shift register ESR, and a selector SELECTOR for selecting a signal from the vertical shift register VSR or a signal from the electronic-shutter shift register ESR such that the selected signal is supplied to the pixel array. The vertical shift register VSR operates in accordance with a start pulse VST and a transfer clock signal VCLK supplied from a timing generator (not shown). The electronic-shutter shift register ESR operates in accordance with a start pulse EST and the transfer clock signal VCLK that are also supplied from the same timing generator (not shown). In accordance with a signal supplied from the timing generator (not shown), the selector SELECTOR selectively supplies the signal received from the vertical shift register VSR or the electronic-shutter shift register ESR to a particular row of the pixel array 4.

Pixels 41 located in each column are connected in common to one of vertical signal lines 49. Each vertical signal line 49 is connected to a storage capacitor 51 for holding the signal output from the pixels 41. The storage capacitors 51 are connected to a horizontal signal line 53 via respective horizontal transfer switch 52. The horizontal transfer switches 52 are controlled by a signal supplied from a horizontal scanning unit 5. The horizontal scanning unit 5 is configured, for example, using a horizontal scanning circuit HSR that is controlled by a signal HST serving as a start pulse and a transfer clock signal HCLK supplied from the timing generator (not shown). The horizontal signal line 53 is connected to an output amplifier 54 such that when one of the horizontal transfer switches 52 is turned on, the signal held on the corresponding storage capacitor 51 is output to the outside of the image pickup device 1 via the output amplifier 54 and an output terminal 55.

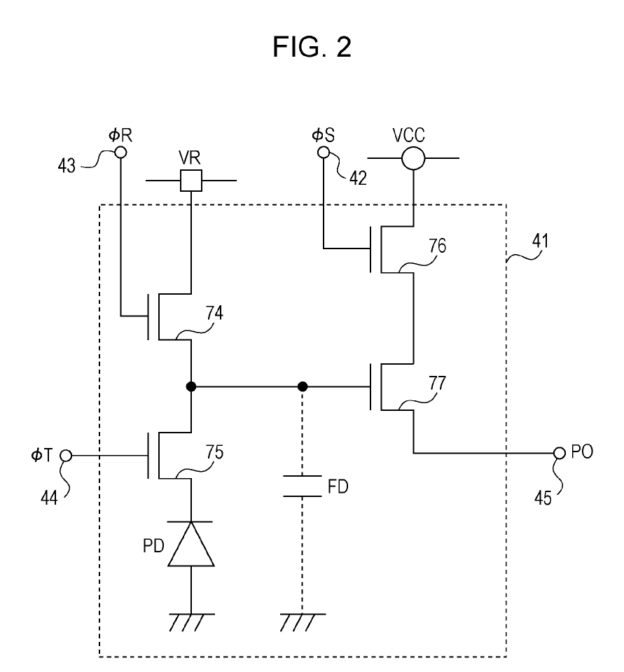

FIG. 2 illustrates an example of a configuration of a pixel 41. Each pixel 41 includes a photodiode PD, a transfer transistor 75, an amplification transistor 77, a reset transistor 74, and a selection transistor 76. An anode of the photodiode PD is connected to ground (GND), while a cathode thereof is connected to a drain terminal of the transfer transistor 75. A source of the transfer transistor 75 is connected to a source of the reset transistor and a gate of the amplification transistor 77. Note that capacitance existing at this node is denoted by FD in FIG. 2. A drain of the reset transistor 74 is connected to a power supply VR. A drain of the selection transistor 76 is connected to a power supply VCC. A drain of the amplification transistor 77 is connected to the power supply VCC via the selection transistor 76, and a source of the amplification transistor 77 is connected to a vertical signal line 49 via a node 45. Note that nodes 42 to 45 shown in FIG. 2 correspond to nodes denoted by similar reference numerals in FIG. 1.

If the transfer transistor 75 turns on in response to a signal φT supplied from the vertical scanning unit 6, a charge accumulated in the photodiode PD is transferred to the capacitor FD. If the reset transistor 74 turns on in response to a signal φR supplied from the vertical scanning unit 6, the electric potential of the capacitor FD is reset to a level corresponding to the power supply VR. When the signals φT and φR are applied to the pixel 41 at the same time, the photodiode PD is also reset to the level corresponding to the power supply VR. Hereafter, the operation of resetting the photodiode PD is also referred to as a pixel reset operation. If the selection transistor 76 turns on in response to a signal φS supplied from the vertical scanning unit 6, the amplification transistor 77 forms a source follower circuit in conjunction with a constant current source 40 shown in FIG. 1 whereby a level corresponding to the electric potential of the gate of the amplification transistor 77 is output to the vertical signal line 49.

The operation according to the present embodiment is explained in further detail below. In the following explanation, it is assumed that the operation is performed such that a whole area image and a partial area image are alternately acquired every frame. That is, a whole area image is acquired by reading signals from pixels over the whole area of the image sensing area while thinning pixels for one frame, and a partial area image is acquired by reading signals from pixels of the partial area for the following frame.

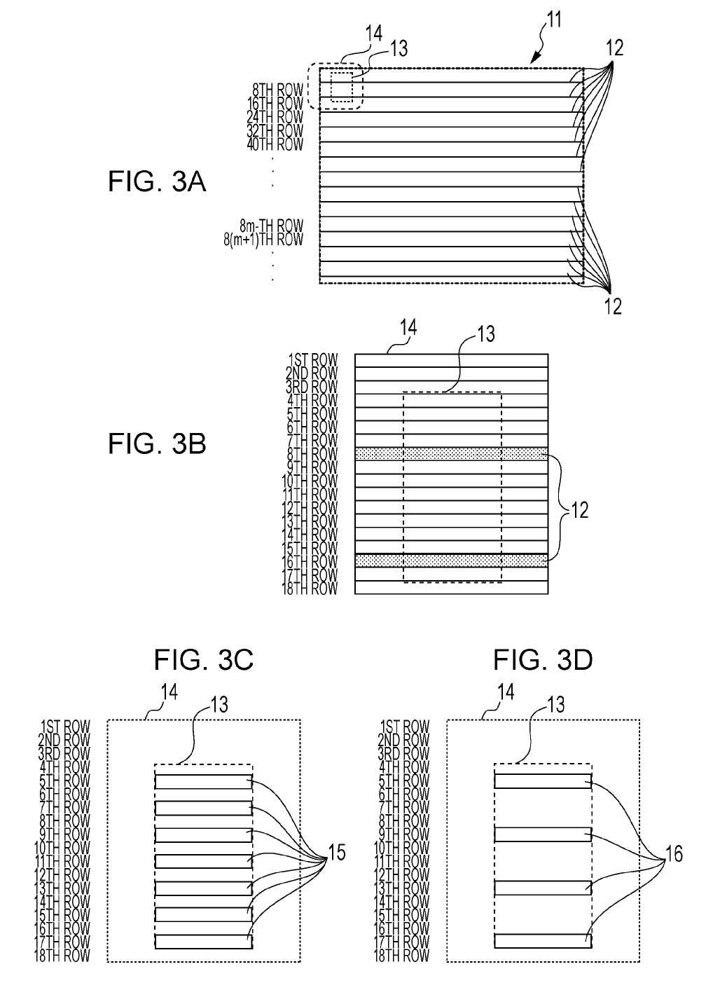

FIG. 3A schematically illustrates an image sensing area of the image pickup device. In FIG. 3A, reference numeral 11 denotes a whole image area corresponding to the whole area of the image sensing area. In general, OB (Optical Black) pixels whose photoelectric conversion part is protected against light are disposed around the image sensing area. However, in the following explanation, for simplicity, it is assumed that the whole image area 11 include no OB (Optical Black) pixels. Reference numerals 12 denote whole-image pixel rows that are defined by partially selecting rows (pixel rows) of the whole image area 11. Signals read from these whole-image pixel rows are used to form an image of the whole image area 11. Reference numeral 13 denotes a partial image area, which is a part extracted from the whole image area 11. In the present embodiment, whole-image pixel rows are read in a first frame, and partial-image pixel rows are read in a second frame following the first frame.

FIG. 3B is an enlarged view of an area 14 shown in FIG. 3A. This area 14 includes two whole-image pixel rows 12.

FIG. 3C illustrates an example in which pixel rows in the partial image area 13 are read every other pixel row. In this example, partial-image pixel rows 15 correspond to 5th, 7th, 9th, . . . , 17th rows, and thus rows that are read are different from the 8th and 16th rows that are read as the whole-image pixel rows 12. More generally, for positive integers n and k, reading of whole-image pixel rows 12 in the first frame is performed by reading one row every n+1 rows of the pixel array (n=7 in the example shown in FIG. 3C), and reading of partial-image pixel rows 15 in the second frame is performed by reading one row every k+1 rows of the pixel array (k=1 in the example shown in FIG. 3C). Note that signals are read from pixel rows that are different for the first frame and the second frame. That is, the pixel rows read in the first frame are located at equal intervals, while the pixel rows read in the second frame are also located at equal intervals, and thus degradation in image quality due to moire is suppressed. Furthermore, because signals are read from pixel rows that are different from each other for the first frame and the second frame, accumulation periods in the first and second frames can be set to be longer than one frame time defined by a frame rate. More specifically, the accumulation period can be set to be up to a value corresponding to a length of two frames.

FIG. 3D illustrates an example in which reading of the partial-image pixel rows 16 is performed by reading one row every k+1 rows of the pixel array (k=3 in the example shown in FIG. 3D). Also in this case, reading of the whole-image pixel rows is performed by reading one row every n+1 rows (n=7), and thus signals are read from pixel rows that are different from each other for the first frame and the second frame. Because the partial-image pixel rows 16 are different from the whole-image pixel rows 12, it is possible to achieve the long accumulation period for each frame even if the resolution for the partial image is switched, and thus it is possible to suppress degradation in image quality.

The image pickup device 1 according to the present embodiment may be used, for example, in a monitoring camera. In the monitoring camera, it is required to provide a higher resolution for a particular area of interest than that of the whole area while providing a moderate resolution for the whole area. It may also require that no degradation occur in image quality due to aliasing. Furthermore, a sampling frequency for the partial image may be set to be higher than for the whole image in the process described above. Note that the sampling frequency corresponds to a frequency of pixels from which the signal is read within the pixel array.

More generally, in the image pickup device according to the present embodiment of the invention, letting both n and k be positive integers, signal reading in the first frame is performed by reading one row every n+1 rows of the pixel array, while signal reading in the second frame is performed by reading one row every k+1 rows of the pixel array such that the rows read in the first frame are different from the rows read in the second frame, whereby making it possible to ensure that the accumulation period is long enough for each frame and degradation in image quality due to aliasing is suppressed. By changing k and/or n while satisfying the above conditions, it is possible to change the resolution while suppressing degradation in image quality because images are formed based on signals acquired at sampling intervals that are constant in each frame.

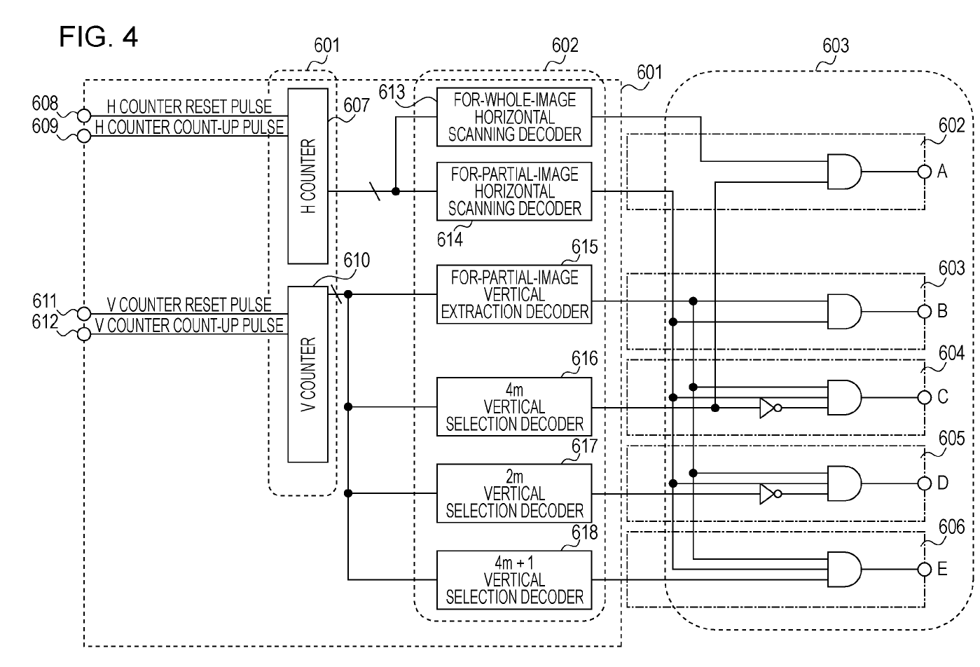

Next, a description is given below as to a control unit configured to achieve the operation according to the present embodiment of the invention. FIG. 4 illustrates an example of a configuration of the control unit that generates signals to drive the vertical scanning circuit and the horizontal scanning circuit according to the present embodiment of the invention. The control unit includes a counter unit 601, a decoder unit 602, and a pulse output unit 603.

The counter unit 601 includes an H counter 607 and a V counter 610. The H counter 607 includes a reset terminal 608 for receiving an H counter reset pulse that causes a count value to be reset, and a count-up pulse input terminal 609 for receiving an H count-up pulse that causes the count value to be incremented. The V counter 610 includes a reset terminal 611 for receiving a V counter reset pulse that causes a count value to be reset, and a count-up pulse input terminal 612 for receiving a V count-up pulse that causes the count value to be incremented.

The decoder unit 602 includes a plurality of decoders. A whole-image horizontal scanning decoder 613 decodes the count value output from the H counter 607 and generates a signal to acquire a whole image, i.e., to select the whole image area 11 shown in FIG. 3A. The logical AND between the signal output from the whole-image horizontal scanning decoder 613 and an output of a 4 m vertical selection decoder 616 that will be described later is determined and the result is output via a terminal A of the pulse output unit. This makes it possible to select one pixel row every 4 m pixel rows (m is a positive integer) in acquisition of a whole image.

A partial-image horizontal scanning decoder 614 decodes the count value output from the H counter 607 and generates a signal to acquire a partial image, i.e., to select the partial image area 13 such as those shown in FIGS. 3A to 3D. The logical AND between the signal output from the partial-image horizontal scanning decoder 614 and an output of a decoder that will be described later is determined and the result is output as a pixel row selection signal from the pulse output unit 603.

A partial-image vertical extraction decoder 615 outputs a signal from a terminal B of the pulse output unit via an AND circuit. More specifically, the partial-image vertical extraction decoder 615 decodes the count value output from the V counter 610 and outputs a pulse to select a partial image area 13 such as those shown in FIGS. 3A to 3D.

The 4 m vertical selection decoder 616 outputs a signal from a terminal C of the pulse output unit via an inverter and an AND circuit. More specifically, the 4 m vertical selection decoder 616 decodes the count value output from the V counter 610 and outputs, from the terminal C, the signal to select one row every 4 m rows (where m is a positive integer).

A 2 m vertical selection decoder 617 outputs a signal from a terminal D of the pulse output unit via an inverter and an AND circuit. More specifically, the 2 m vertical selection decoder 617 decodes the count value output from the V counter 610 and outputs from the terminal D the signal to select one row every 2 m rows (where m is a positive integer).

A 4 m+1 vertical selection decoder 618 outputs a signal from a terminal E of the pulse output unit via an AND circuit. More specifically, the 4 m+1 vertical selection decoder 618 decodes the count value output from the V counter 610 and outputs, from the terminal E of the pulse output unit 603, the signal to select only (4 m+1)th rows (where m is a positive integer). For example, when the whole-image pixel rows are given by 4 m-th rows where m is a positive integer, the partial-image pixel rows should be selected so as to be different from the whole-image pixel rows. Furthermore, the partial-image pixel rows may be selected based on the output of the 4 m+1 vertical selection decoder 618. Thus, both the whole image and the partial image are formed based on signals output from pixel rows that are equally spaced and that are selected such that there is no overlap between the whole image and the partial image. This makes it possible to set the accumulation period to be longer than one frame period determined by the frame rate and suppress degradation in image quality.

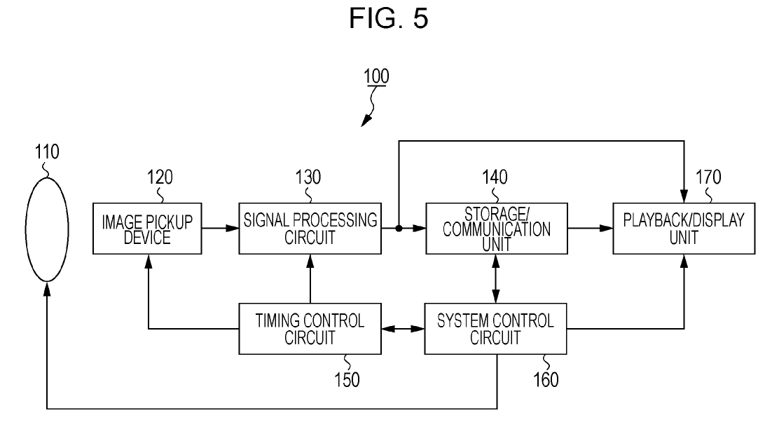

Referring to FIG. 5, a description is given below as to an example of a configuration of an image pickup system using the image pickup device described above.

An image pickup system 100 includes, for example, an optical unit 110, an image pickup device 120, a signal processing circuit 130, a storage/communication unit 140, a timing control circuit 150, a system control circuit 160, and a playback/display unit 170.

The optical unit 110 includes an optical system such as a lens configured to focus light from a subject so as to form an image of the subject on the pixel array including a plurality of pixels arranged in the form of a two-dimensional matrix in the image pickup device 120. The image pickup device 120 outputs a signal corresponding to the optical image formed on the pixel array in synchronization with a signal output from the timing control circuit 150.

The signal output from the image pickup device 120 is input to the signal processing circuit 130 serving as a signal processing unit. The signal processing circuit 130 performs processing such as an analog-to-digital conversion on the input electric signal in accordance with a predetermined procedure defined in a program or the like. A signal obtained as a result of the process performed by the signal processing circuit 130 is supplied to the storage/communication unit 140. The storage/communication unit 140 outputs a signal for forming an image to the playback/display unit 170. In accordance with the received signal, the playback/display unit 170 displays a moving image or still image. The storage/communication unit 140 is configured to also receive a signal from the signal processing circuit 130, communicate with the system control circuit 160, and store the image signal in a storage medium (not shown).

The system control circuit 160 is responsible for general control of the operation of the image pickup system. More specifically, the system control circuit 160 controls the operation of the optical unit 110, the timing control circuit 150, the storage/communication unit 140, and the playback/display unit 170. The system control circuit 160 also includes a storage apparatus (not shown) including a storage medium in which a program to control the operation of the image pickup system is stored.

The timing control circuit 150 controls the driving timing of the image pickup device 120 and the signal processing circuit 130 under the control of the system control circuit 160 serving as a control unit.

The system control circuit 160 may include a program that defines how to determine the whole image and the partial image.

Note that the driving method employed by the system control circuit 160 is not limited to that described above, but the system control circuit 160 may perform the driving process according to other methods such as a progressive scanning method in which pixels in an effective pixel area are scanned sequentially row by row starting from a first row, an interlace scanning method in which scanning is performed every other row, etc. Note that the image pickup system described above may be used in other embodiments described below.

As described above, in the first embodiment of the invention, the accumulation period can be set to be longer than one frame period determined by the frame rate, and degradation in image quality can be suppressed.

### Second Embodiment

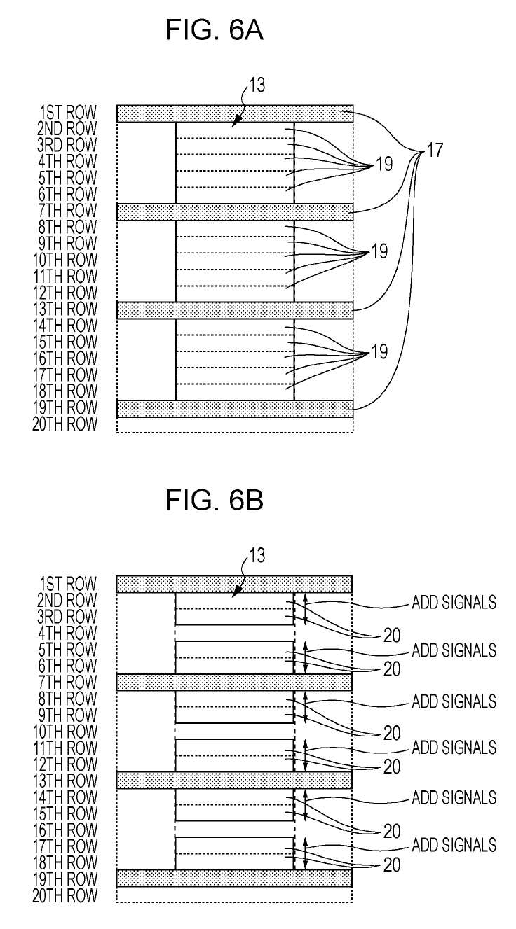

A second embodiment of the present invention is described below. FIGS. 6A and 6B schematically illustrate a partial image area 13 and a nearby area in an image sensing area. Also in this embodiment, as in the first embodiment, signals are read from whole-image pixel rows in a first frame, while signals are read from partial-image pixel rows in a second frame following the first frame.

FIG. 6A, as FIGS. 3B to 3D, illustrates an area associated with a partial image and a surrounding area extracted from an image sensing area. In FIG. 6A, an area 13 including 2nd to 18 th rows surrounded by a dotted line corresponds to a partial image area. Whole-image pixel rows 17 are rows that are defined by selecting one row every 6 rows from an image sensing area. In the example shown in FIG. 6A, 1st, 7th, 13th, and 19th rows are extracted as the whole-image pixel rows 17. On the other hand, partial-image pixel rows 19 correspond to rows in the image sensing area excluding the whole-image pixel rows 17. However, if all partial-image pixel rows 19 shown in FIG. 6A are simply read, the sampling intervals at which pixels are read in a vertical direction to form the partial image will not be constant, which results in degradation in quality of the obtained image.

In the present embodiment, in view of the above, signals obtained from vertically adjacent pixels are added together. More specifically, in the example shown in FIG. 6A, addition is performed for the partial-image pixel rows 19 such that signals from two vertically adjacent pixels are added together between 2nd and 3rd rows, between 5th and 6th rows, between 8th and 9th rows, and so on, as shown in FIG. 6B. The centroids of resultant signals obtained as the result of the addition are located between the 2nd and 3rd rows, between the 5th and 6th rows, between 8th and 9th rows, and so on, and thus the centroids of the resultant signals obtained as the result of the addition are located at equal intervals. Therefore, the centroids of the signals output from the image pickup device are located at equal intervals for both the whole image and the partial image, and thus no degradation in image quality due to aliases occurs.

In the example shown in FIG. 6B, the partial image has a high resolution. The resolution of the partial image may be set to be lower, for example, by adding pixel signals of partial-image pixel rows 19 between 2nd and 6th rows, between 8th and 12th rows, and between 14th and 18th rows. In this case, the centroids of resultant signals obtained as the result of the addition are located in the 4th, 10th, and 16th rows, and thus the sampling for the partial image is performed at equal intervals.

The above discussion may be generalized as follows. In the second frame, signals from pixels associated with the partial-image pixel row 19 are added together such that the centroids of the resultant signals are located at equal intervals. In other words, when n and k are integers equal to or greater than 1, signals are read from the pixel array every (n+1)th row in the first frame, while in the second frame, signals are read from a first set of rows that are different from those from which the signals are read in the first frame and that are defined by selecting every (k+1)th row from the pixel array. Furthermore, in the second frame, signals are read from pixels that are different from the pixels from which the signals are read in the first frame and that are located in a second set of rows defined by selecting every (k+1)th rows from the pixel array such that the second set of rows are different from the first set of rows. In the second frame, the signals read from the first and second sets of rows are added together.

Note that there is no particular restriction on locations at which signals are added together. For example, a storage capacitor such as those shown in FIG. 1 may be disposed in each column of the pixel array such that signals are added at the storage capacitors. In the configuration shown in FIG. 2 in which a plurality of photodiodes PD are connected to one amplification transistor 77, the addition may be performed at the node of the gate electrode of the amplification transistor 77. Instead of performing the addition in the inside of the image pickup device, the addition may be performed externally by the signal processing circuit 130 shown in FIG. 5.

In the present embodiment, in addition to the benefits obtained in the first embodiment, a further benefit is achieved in terms of an increase in a vertical resolution in the first frame by adding signals already read in the first frame.

### Third Embodiment

In the first and second embodiments described above, it has been assumed that the image pickup device is of a monochrome type. However, the present invention is also applicable to a color image pickup device. In a third embodiment described below, the invention is applied to a color image pickup device having a color filter of an RGB Bayer array type.

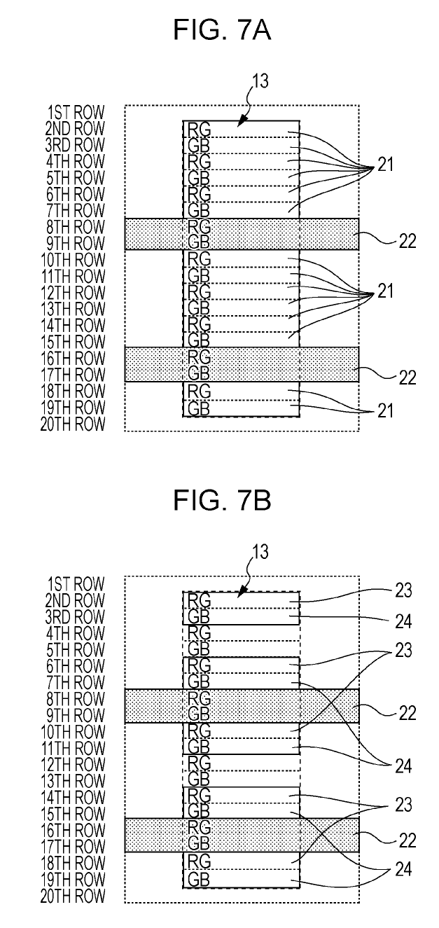

FIGS. 7A and 7B schematically illustrate a partial image area 13 and a nearby area in an image sensing area. In this embodiment as in the previous embodiments, signals are read from partial-image pixel rows in a first frame, and signals are read from whole-image pixel rows in a second frame following the first frame.

In the Bayer color filter, rows are arranged such that RG rows and GB rows are alternately located. Note that RG rows are rows in which R and G filter elements are alternately located, while GB rows are rows in which G and B filter elements are alternately located. In the present embodiment, whole-image pixel rows 22 include a set of rows including RG rows (8th and 16th rows in the example shown in FIGS. 7A and 7B) defined by selecting one row every 8 rows from the image sensing area and a set of rows including GB rows (9th and 17th rows in the example shown in FIGS. 7A and 7B) adjacent to the above RG rows. Partial-image pixel rows 21 correspond to rows in the image sensing area excluding the whole-image pixel rows 22. However, if all partial-image pixel rows 21 shown in FIG. 7A are simply read, sampling intervals at which pixels are read in a vertical direction to form the partial image will not be constant, which results in degradation in quality of an obtained image.

In the present embodiment, to avoid the above situation, reading is performed as follows. That is, as shown in FIG. 7B, in a first frame, signals are read from rows 22 including the set of rows including RG rows (8th and 16th rows shown in FIGS. 7A and 7B) and the set of rows including GB rows (9th and 17th rows shown in FIGS. 7A and 7B). As shown in FIG. 7B, in a second frame, signals are read from a first set of rows including RG rows 23 (2nd, 6th, 10th, 14th and 18th rows) defined by selecting one row every 4 rows from the partial-image pixel row 21. Also in the second frame, signals are read from a second set of rows including GB rows 24 (3rd, 7th, 11th, 15th and 19th rows) that are defined by selecting one row every 4 rows from the partial-image pixel rows 21 such that the extracted rows are adjacent to the rows in the first set of rows.

The reading algorithm described above may be generalized as follows. When n and k are integers equal to or greater than 1, signal reading in the first frame is performed by reading one pixel row every n+1 pixel rows, while signal reading in the second frame is performed by reading pixels in the first set of rows defined by selecting one row every k+1 rows from the pixel array. Furthermore, in the second frame, in addition to the first set of rows, signals are read from pixels that are different from the pixels read in the first frame and that are located in the second set of rows adjacent to the rows of the first set of rows.

Thus, in the present embodiment, benefits similar to those obtained in the first embodiment are achieved also for the image pickup device including a color filter having filter elements of a plurality of colors disposed over the pixel area. Besides, the resolution of each frame is allowed to be changed while maintaining the long accumulation period for each frame and without causing significant degradation in image quality, as long as the above-described conditions are satisfied.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2009-136370 filed Jun. 5, 2009, which is hereby incorporated by reference herein in its entirety.

What is claimed is:

1. An image pickup device comprising:
a pixel array including pixels each configured to output a signal obtained via a photoelectric conversion the pixels being arranged in a matrix; and
a control unit that selects pixels of the pixel array in units of rows and outputs signals from the selected pixels;
the control unit configured to control outputting of signals such that for integers n and k greater than 1, in a first frame, first signals are output from first pixels in every (n+1)th row of the pixel array, and
in a second frame following the first frame, second signals are output from second pixels that are different from the pixels from which the first signals are output and that are located in a first set of rows defined by selecting every (k+1)th row of the pixel array.

2. The image pickup device according to claim 1, wherein the control unit controls outputting of signals such that in the second frame, in addition to the second pixels, third signals are output from third pixels that are different from the pixels from which the signals are output in the first frame and that are located in a second set of rows defined by selecting every (k+1)th row of the pixel array such that the selected rows of the second set of rows are different from the rows of the first set of rows.

3. The image pickup device according to claim 2, wherein the second pixels are located adjacent to corresponding third pixels.

4. The image pickup device according to claim 2, wherein in the second frame, the second signals are added to the third signals.

5. The image pickup device according to claim 1, wherein the pixel array includes a color filter having filter elements of a plurality of colors.

6. The image pickup device according to claim 1, wherein:
the first pixels are associated with a whole area of the pixel array; and
the second pixels are associated with a partial area of the whole area of the pixel array.

7. An imaging system comprising:
the image pickup device according to claim 1;
an optical system configured to form an image on the pixel array; and
a processing unit configured to process a signal output from the image pickup device.

8. A method of driving an image pickup device including a pixel array including pixels each configured to output a signal obtained via a photoelectric conversion, the method comprising, for integers n and k greater than 1,
in a first frame, outputting first signals from first pixels in every (n+1)th row of the pixel array, and
in a second frame following the first frame, outputting second signals from second pixels that are different from the pixels from which the first signals are output and that the second pixels are located in a first set of rows defined by selecting every (k+1)th row of the pixel array.

9. The method according to claim 8, further comprising controlling outputting of signals such that in the second frame, in addition to the second pixels, third signals are output from third pixels that are different from the pixels from which the signals are output in the first frame and that are located in a second set of rows defined by selecting every (k+1)th row of the pixel array such that the selected rows of the second set of rows are different from the rows of the first set of rows.

10. The method according to claim 9, wherein the second pixels are located adjacent to corresponding third pixels.

11. The method according to claim 9, further comprising adding, in the second frame, the second signals to the third signals.

12. The method according to claim 8, wherein the pixel array includes a color filter having filter elements of a plurality of colors.

13. The method according to claim 8, wherein:
the first pixels are associated with a whole area of the pixel array; and
the second pixels are associated with a partial area of the whole area of the pixel array.

14. The method according to claim 8, further comprising:
forming an image on the pixel array; and
processing a signal output from the device.
